(19) United States
(12) Patent Application Publication
(10) Pub. No.: US 2015/0274033 A1
(43) Pub. Date: Oct. 1, 2015

(54) WHEEL CONTROL DEVICE, VEHICLE, AND WHEEL CONTROL METHOD

(71) Applicants: Etsuo KATSUYAMA, (US); Takao KOBAYASHI, (US); Hideki SUGIURA, Nagakute-shi, Aichi (JP)

(72) Inventors: Etsuo Katsuyama, Hiratsuka-shi (JP); Takao Kobayashi, Nagakute-shi (JP); Hideki Sugiura, Nagakute-shi (JP)

(73) Assignee: TOYOTA JIDOSHA KABUSHIKI KAISHA, Toyota-shi, Aichi (JP)

(21) Appl. No.: 14/433,553

(22) PCT Filed: Oct. 4, 2012
(86) PCT No.: PCT/JP2012/075754

§ 371 Date: Apr. 3, 2015

(51) Int. Cl. B60L 15/20

(52) U.S. Cl. CPC B60L 15/2036; B60L 15/2009

(57) ABSTRACT

A control unit controlling torque of four motors capable of independently driving respective wheels, and setting a predetermined reference torque to the four motors based on first information from a driver input, and includes a distributed torque limitation mode wherein at least one of first motors from the four motors are controlled at a torque acquired by distributing a first distributed torque to the predetermined reference torque through addition to the predetermined reference torque based on second information of vehicle motion state; at least one of second motors different from the first motors are controlled at a torque acquired by distributing a second distributed torque to the predetermined reference torque through subtraction from the predetermined reference torque; and the first and second distributed torque are limited to prevent a torque acting direction from changing before and after the distribution through addition and the distribution through subtraction.

### TECHNICAL FIELD

The present invention relates to a technology of controlling a plurality of wheels provided for a vehicle.

### BACKGROUND ART

Patent Literature 1 discloses a technology of controlling motors built into respective wheels of a vehicle. According to this technology, when a fluctuation in a pitch rate of the vehicle (a change in an attitude of the vehicle) is detected, there is executed such pitch control that a drive force for one of front wheels and rear wheels are reduced and a reduced amount of the drive force is applied to the other wheels.

### CITATION LIST

### Patent Literature

[PTL 1] JP 2007-118898 A

### SUMMARY OF INVENTION

### Technical Problem

The pitch control disclosed in Patent Literature 1 is capable of reducing the pitch rate of the vehicle when the vehicle passes over a step or the like of a road surface. However, in a case of torque control for motors of driving the front wheels and the rear wheels, respectively, when a torque distribution to the respective motors is controlled in order to realize an appropriate vehicle motion, there may occur such a phenomenon that the torques of the motors for the front wheels and the torques of the motors for the rear wheels are opposite in sign to each other. For example, due to the torque distribution, while torques in a driving direction (powering direction) are generated on predetermined motors, torques in a braking direction (regenerating direction), which is opposite to the driving direction, may be generated on the other motors. In this case, for example, it is known that the sign of the torque is inverted in a process of reduction of a distributed torque from a reference torque on each of the motors on the one side, and hence a phase switches from the one in which an electrical loss of the motor decreases to the one in which the electrical loss increases. As a result, an electrical loss of the motors as a whole increases compared with a case in which the torque distribution is not controlled, resulting in a fear of an increase in power consumption. Thus, when the motors of this type capable of independently driving the respective plurality of wheels are designed, a technology of suppressing the increase in the power consumption, which may be caused by the control of the torque distribution, is required.

### Solution to Problem

The present invention has been made in view of the above-mentioned problem, and an object thereof is to provide a technology effective for, in a vehicle including a plurality of motors capable of independently driving a plurality of wheels provided for the vehicle, appropriately controlling a vehicle motion through a torque distribution to the respective motors and suppressing an increase in a power consumption, which may be caused by the control.

In order to achieve the above-mentioned object, according to one embodiment of the present invention, there is provided a wheel control device configured to control a plurality of wheels provided for a vehicle. The wheel control device includes at least a control part. The control part has a function of setting a predetermined reference torque to each of the plurality of motors based on first information on an input operation by a driver. A corresponding one of the plurality of motors can be controlled based on the set predetermined reference torque. Further, the control part includes a distributed torque limitation mode. In the distributed torque limitation mode: one or a plurality of first motors out of the plurality of motors are controlled at a torque acquired by distributing a first distributed torque to the predetermined reference torque through addition to the predetermined reference torque based on second information on a motion state of the vehicle; one or a plurality of second motors different from the one or a plurality of first motors are controlled at a torque acquired by distributing a second distributed torque to the predetermined reference torque through subtraction from the predetermined reference torque; and the first distributed torque and the second distributed torque are limited so as to prevent, for each of the one or a plurality of first motors and the one or a plurality of second motors, an acting direction of a torque from changing before and after the distribution through addition and the distribution through subtraction. In other words, the control part has a function as means for setting or calculating the predetermined reference torque and a function as means for controlling the one or a plurality of first motors and the one or a plurality of second motors while limiting the first distributed torque and the second distributed torque. In this case, the first distributed torque and the second distributed torque may be the same in the magnitude, or may be different in the magnitude from each other. Moreover, the plurality of motors may only include the one first motors and the one second motor, or may include the plurality of first motors and the plurality of second motors that are the same in the number. In order to detect the first information and the second information, one or a plurality of sensors provided for the vehicle for detecting the respective pieces of information are preferably used.

The vehicle control device configured as described above prevents the acting directions of the torques of both of the one or a plurality of first motors and the one or a plurality of second motors from changing before and after the torque distribution between the driving direction (powering direction) and the braking direction (regenerating direction). In other words, the sign of the torque is prevented from changing. For example, the sign of the torque is prevented from inverting in the process of the reduction of the second distributed torque from the reference torque on the second motor, and the phase does not switch from the one in which an electrical loss of the motor decreases to the one in which the electrical loss increases. As a result, an increase in an electrical loss of the motors as a whole is suppressed, and hence an increase in a power consumption is suppressed. Thus, while the vehicle motion is appropriately controlled, it is possible to suppress the increase in the power consumption, which may be caused by the control.

In the wheel control device according to one embodiment of the present invention, it is preferred that, in the distributed torque limitation mode, when a magnitude of at least one of the first distributed torque or the second distributed torque is more than a magnitude of the predetermined reference torque, the control part limit the at least one of the first distributed torque or the second distributed torque so that the magnitude of the at least one of the first distributed torque or the second distributed torque is equal to or less than the magnitude of the predetermined reference torque. In this case, the magnitude of the at least one of the first distributed torque or the second distributed torque is selected in a predetermined range depending on the magnitude of the reference torque, to thereby reliably prevent the change in the acting direction of the torque for each of the one or a plurality of first motors and the one or a plurality of second motors.

In the wheel control device according to one embodiment of the present invention, it is preferred that, in the distributed torque limitation mode, when the magnitude of at least one of the first distributed torque or the second distributed torque is more than the magnitude of the predetermined reference torque, the control part limit the at least one of the first distributed torque or the second distributed torque so that the magnitude of the at least one of the first distributed torque or the second distributed torque matches the magnitude of the predetermined reference torque. In this case, the magnitude of the at least one of the first distributed torque or the second distributed torque is simply selected depending on the magnitude of the reference torque, to thereby reliably prevent the change in the acting direction of the torque for each of the one or a plurality of first motors and the one or a plurality of second motors.

In the wheel control device according to one embodiment of the present invention, it is preferred that the plurality of motors only include one first motor built into one of the left wheel and the right wheel corresponding to each other out of the plurality of wheels and one second motor built into another one of the left wheel and the right wheel. In this case, it is preferred that the control part set the first distributed torque relating to the one first motor and the second distributed torque relating to the one second motor to the same magnitude. With this, a change in a total driving torque of at least the two wheels before and after the torque distribution is suppressed, and the control may be performed without providing a sense of discomfort to a vehicle occupant of the vehicle.

In the wheel control device according to one embodiment of the present invention, it is preferred that the plurality of motors only include two first motors respectively built into two wheels out of four wheels serving as the plurality of wheels and two second motors respectively built into two wheels other than the two wheels. In this case, it is preferred that the control part set the first distributed torque relating to each of the two first motors and the second distributed torque relating to each of the two second motors to the same magnitude. With this, a change in a driving torque of a total of the four wheels before and after the torque distribution is suppressed, and the control may be performed without providing a sense of discomfort to a vehicle occupant of the vehicle.

In the wheel control device according to one embodiment of the present invention, it is preferred that the second information include first motion information on a roll motion or a pitch motion of the vehicle and second motion information on a yaw motion of the vehicle. In this case, it is preferred that the control part be configured to: selectively carry out any one of roll motion control or pitch motion control of setting the first distributed torque and the second distributed torque based on the first motion information and yaw motion control of setting the first distributed torque and the second distributed torque based on the second motion information; select the distributed torque limitation mode when the roll motion control or the pitch motion control is carried out; and avoid selecting the distributed torque limitation mode when the yaw motion control is carried out. In short, regarding a priority level of the limitation on the distributed torques, the priority based is set to be higher to the pitch motion control or the roll motion control relating to ride comfort of the vehicle occupant of the vehicle than to the yaw motion control relating to steering stability of the vehicle. With this, while the ride comfort of the vehicle occupant of the vehicle is sacrificed, the vehicle motion can be appropriately controlled so that the steering stability of the vehicle is prevented from being lost as much as possible. Further, it is possible to suppress the increase in the power consumption, which may be caused by this control.

In the wheel control device according to one embodiment of the present invention, it is preferred that, in the distributed torque limitation mode, when a reduction in a power consumption is not necessary on the plurality of motors, the control part avoid limiting the first distributed torque and the second distributed torque. With this, whether the distributed torque is to be limited or not can be selected in response to a request issued as necessary, which is rational.

In the wheel control device according to one embodiment of the present invention, it is preferred that when, in an electricity storage device installed on the vehicle as a drive source of the plurality of motors, a ratio of a remaining charge amount to a charge capacity in a fully charged state is less than a predetermined threshold, the control part determine that the reduction in the power consumption on the plurality of motors is not necessary. In this case, examples of the electricity storage device include a battery, a capacitor, or the like. Moreover, the predetermined threshold may be a constant value set in advance, or a variable value variably set depending on the vehicle motion state and the like. With this, whether the distributed torque is to be limited or not can be selected in response to a request issued from the electricity storage device side, which is rational.

According to one embodiment of the present invention, there is provided a vehicle, including: a plurality of wheels; a plurality of motors capable of independently driving the plurality of wheels; and a motor control device for controlling the plurality of motors, in which the motor control device includes the above-mentioned wheel control device. With this, it is possible to realize the vehicle capable of appropriately controlling the vehicle motion while suppressing the increase in the power consumption, which may be caused by the control.

According to one embodiment of the present invention, there is provided a wheel control method for controlling a plurality of wheels provided for a vehicle. The wheel control method includes the steps of: setting a predetermined reference torque to each of the plurality of motors based on first information on an input operation by a driver; and using a distributed torque limitation mode. The wheel control method may further include another step. In the distributed torque limitation mode: one or a plurality of first motors out of the plurality of motors are controlled at a torque acquired by distributing a first distributed torque to the predetermined reference torque through addition to the predetermined reference torque based on second information on a motion state of the vehicle; one or a plurality of second motors different from the one or a plurality of first motors are controlled at a torque acquired by distributing a second distributed torque to the predetermined reference torque through subtraction from the predetermined reference torque; and the first distributed torque and the second distributed torque are limited so as to prevent, for each of the one or a plurality of first motors and the one or a plurality of second motors, an acting direction of a torque from changing before and after the distribution through addition and the distribution through subtraction. With this, the acting directions of the torques of both of the one or a plurality of first motors and the one or a plurality of second motors are prevented from changing before and after the torque distribution between the driving direction (powering direction) and the braking direction (regenerating direction). In other words, the sign of the torque is prevented from changing. As a result, an increase in an electrical loss of the motors as a whole can be suppressed, and hence the increase in the power consumption can be suppressed. Thus, while the vehicle motion is appropriately controlled, it is possible to suppress the increase in the power consumption, which may be caused by the control.

### BRIEF DESCRIPTION OF DRAWINGS

FIG. 1 is a diagram illustrating a schematic configuration of a drive mechanism of a vehicle 10 according to the present invention.

FIG. 2 is a diagram illustrating a schematic configuration of a control unit 30 of FIG. 1.

FIG. 3 is a diagram illustrating a processing flow of motor torque control.

FIG. 4 is a graph showing a relationship between a torque of a motor and an electrical loss in a case in which the motor torque control of FIG. 3 is in a distributed torque limitation mode.

FIG. 5 is a graph showing the relationship between the torque of the motor and the electrical loss in a case in which the motor torque control of FIG. 3 is not in the distributed torque limitation mode.

FIG. 6 is a diagram illustrating roll motion control on the vehicle 10 of FIG. 1.

FIG. 7 is a diagram illustrating pitch motion control on the vehicle 10 of FIG. 1.

FIG. 8 is a diagram illustrating yaw motion control on the vehicle 10 of FIG. 1.

### DESCRIPTION OF EMBODIMENT

A description is now given of a vehicle 10 according to an embodiment of the present invention referring to the drawings.

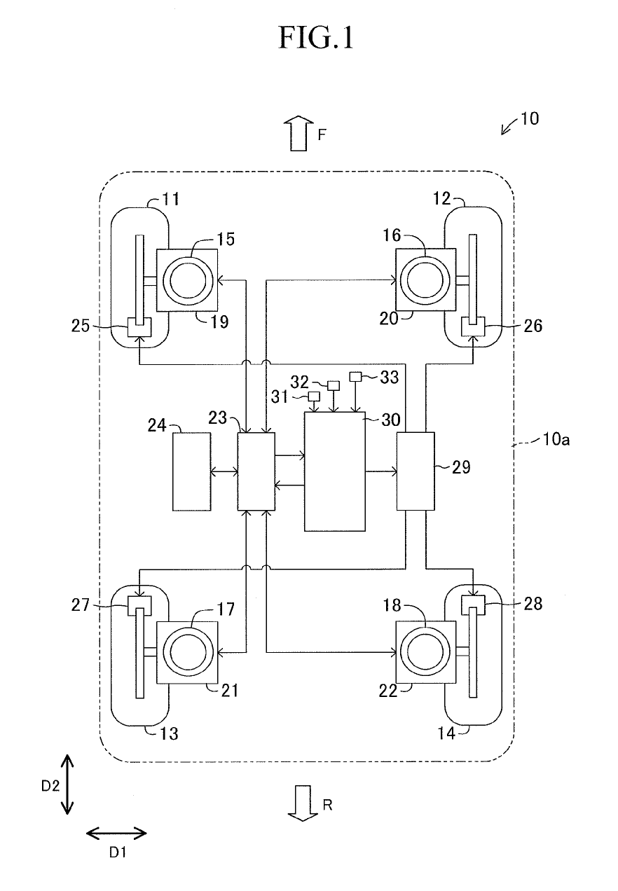

FIG. 1 is referred to for a schematic configuration of a drive mechanism of the vehicle 10. The arrow F of FIG. 1 indicates a forward direction of the vehicle 10, and the arrow R indicates a backward direction of the vehicle 10. Moreover, the arrow D1 of FIG. 1 indicates a lateral direction of the vehicle 10, and the arrow D2 indicates a longitudinal direction of the vehicle 10. The vehicle 10 corresponds to “vehicle” of the present invention, and includes, as wheels, front left and right wheels 11 and 12 and rear left and right wheels 13 and 14. The front left and right wheels 11 and 12 are supported together or independently on a vehicle body 10a as a sprung mass of the vehicle 10 via suspension mechanisms 15 and 16. Moreover, the rear left and right wheels 13 and 14 are supported together or independently on the vehicle body 10a of the vehicle 10 via suspension mechanisms 17 and 18.

Electric motors 19 and 20 are respectively built into the front left and right wheels 11 and 12, and each of the motors 19 and 20 provides a function of transmitting a torque to the corresponding wheel. Similarly, electric motors 21 and 22 are respectively built into the rear left and right wheels 13 and 14, and each of the motors 21 and 22 provides a function of transmitting a torque to the corresponding wheel. The motors 19 to 22 are so-called in-wheel motors, and are respectively disposed at unsprung locations of the vehicle 10 together with the front left and right wheels 11 and 12 and the rear left and right wheels 13 and 14. In addition, the respective motors 19 to 22 are independently controlled, to thereby control driving torques for respectively driving the front left and right wheels 11 and 12 and the rear left and right wheels 13 and 14 in a driving direction (also referred to as “powering direction”) or a braking direction (also referred to as “regenerating direction”).

Each of those motors 19 to 22 is constructed as, for example, an AC synchronous motor. In this case, a DC power of an electricity storage device 24 (a battery, a capacitor, or the like) installed on the vehicle 10 as a drive source is converted via an inverter 23 into an AC power. The AC power is supplied to the respective motors to drive the respective motors, thereby applying the driving torques in the driving direction or the braking direction to the front left and right wheels 11 and 12 and the rear left and right wheels 13 and 14. Moreover, regeneration control can also be performed on those motors 19 to 22 through use of rotational energy of the front left and right wheels 11 and 12 and the rear left and right wheels 13 and 14. Note that, the four motors 19 to 22 may have such a structure that the respective motors are directly connected to the corresponding wheels, or such a structure that a speed reduction mechanism is interposed between each of the motors and the corresponding wheel.

Brake mechanisms 25, 26, 27, and 28 are respectively provided between the four wheels 11 to 14 and the four corresponding motors 19 to 22. Each of the brake mechanisms 25 to 28 is constructed as a publicly-known braking device such as a disk brake or a drum brake. Those brake mechanisms 25 to 28 are connected, for example, to a brake actuator 29 for operating pistons of brake calipers, brake shoes (both are not shown), and the like for generating the braking force on each of the wheels 11 to 14 though use of a hydraulic pressure from, for example, a master cylinder (not shown). The inverter 23 and the brake actuator 29 are each connected to a control unit 30.

Note that, the vehicle 10 described above can employ, other than the configuration in which the four wheels 11 to 14 are respectively driven by the four motors 19 to 22 (namely, four-wheel motor vehicle), such a configuration that two wheels including the front left and right wheels 11 and 12 are respectively driven by the two motors 19 and 20 (namely, front-wheel drive two-wheel motor vehicle), and such a configuration that two wheels including the rear left and right wheels 13 and 14 are respectively driven by the two motors 21 and 22 (namely, rear-wheel drive two-wheel motor vehicle).

A first detection sensor 31, a second detection sensor 32, and a third detection sensor 33 are each connected to the control unit 30, and signals output from various sensors including the first to third detection sensors 31 to 33 are input to the control unit 30. The first detection sensor 31 is configured as a detection sensor (operation state detection means) for detecting an operation state operated by a driver for driving the vehicle 10. The second detection sensor 32 is configured as a detection sensor (motion state detection means) for detecting a motion state generated on the vehicle body 10a (sprung mass) of the vehicle 10 during traveling. The third detection sensor 33 is configured as a detection sensor (disturbance detection means) for detecting disturbance acting on the vehicle 10 during the travelling.

Examples of the first detection sensor 31 include a steering angle sensor for detecting an operation amount (steering angle) by the driver on a steering wheel (not shown) for steering the vehicle, an accelerator sensor for detecting an operation amount (such as a depression amount, an angle, and a pressure) on an accelerator pedal (not shown) by the driver, a throttle sensor for detecting an opening degree of a throttle, which is provided for an engine (not shown) and acts in response to the operation on the accelerator pedal, a brake sensor for detecting an operation amount (such as a depression amount, an angle, and a pressure) on a brake pedal (not shown) by the driver, a parking brake sensor for detecting on/off states of a parking brake (not shown), an ignition sensor for detecting on/off states of an ignition switch (not shown), and an electricity storage sensor for detecting an electricity storage state of the electricity storage device 24.

Examples of the second detection sensor 32 include a sprung mass vertical acceleration sensor for detecting a vertical acceleration of the vehicle body 10a (sprung mass) in a vertical direction, a vehicle speed sensor for detecting a vehicle speed of the vehicle 10, a yaw rate sensor for detecting a yaw rate generated on the vehicle 10, a pitch rate sensor for detecting a pitch rate generated on the vehicle 10, and a roll rate sensor for detecting a roll rate generated on the vehicle 10.

Examples of the third detection sensor 33 include a stroke sensor for detecting each of stroke amounts of the suspension mechanisms 15 to 18, and an unsprung mass vertical acceleration sensor for detecting a vertical acceleration of an unsprung mass of the vehicle 10 in the vertical direction, which includes the wheels 11 to 14.

The control unit 30 has a function of, based on signals output from various sensors including the first to third detection sensors 31 to 33, outputting a control signal for controlling the motors 19 to 22 to the inverter 23 and outputting a control signal for controlling the brake mechanism 25 to 28 to the brake actuator 29. As a result of this function, the control unit 30 can control the vehicle 10 while grasping a traveling state of the vehicle 10 and a behavior of the vehicle body 10a. This control unit 30 includes, as a principal component, a microcomputer that includes a CPU, a ROM, and a RAM, and executes various programs. The control unit 30, which forms a wheel control device for controlling the four wheels 11 to 14 provided for the vehicle 10 and controls the four motors 19 to 20, constructs “wheel control device” and “motor control device” of the present invention.

Specifically, regarding the control of the traveling state of the vehicle 10, for example, when the control unit 30 detects that the driver is operating the accelerator pedal based on the signal output from the first detection sensor 31, the control unit 30 can calculate requested driving torques (requested driving forces) corresponding to an accelerator operation amount caused by this operation, namely, driving torques (drive forces) to be generated respectively by the motors 19 to 22 for controlling to travel the vehicle 10. Moreover, for example, when the control unit 30 detects that the driver is operating the brake pedal based on the output signal output from the first detection sensor 31, the control unit 30 can calculate requested braking torques (requested braking forces) corresponding to a brake operation amount caused by this operation, namely, requested braking torques (requested braking forces) to be generated by the motors 19 to 22 and the brake mechanisms 25 to 28 in cooperation in order to decelerate the vehicle 10. Then, based on signals input from the inverter 23, specifically, signals representing electric energies and current values supplied respectively to the motors 19 to 22 during powering control and signals representing electric energies and current values regenerated respectively by the motors 19 to 22 during regeneration control, the control unit 30 carries out motor control so that the respective output torques of the motors 19 to 22 follow the desired requested braking torques or requested driving torques.

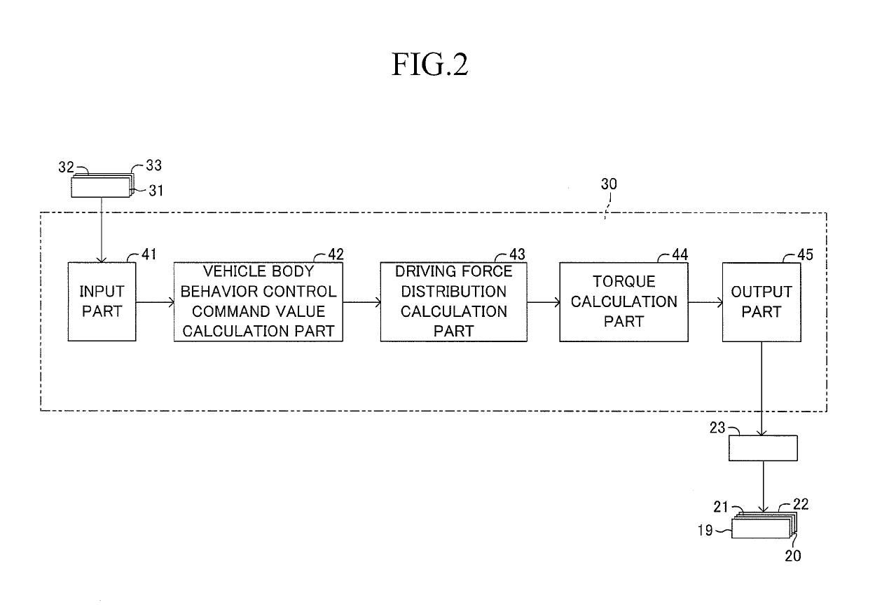

The control unit 30 appropriately controls a distribution of the torques generated respectively by the respective in-wheel motors 19 to 22, to thereby control the vehicle 10 to travel, and control the roll motion, the pitch motion, and the yaw motion as behaviors generated on the vehicle body 10a (sprung mass). Therefore, as illustrated in FIG. 2, the control unit 30 includes an input part 41 as input means, a vehicle body behavior control command value calculation part 42 as vehicle body behavior control command value calculation means, a driving force distribution calculation part 43 as driving force distribution calculation means, a torque calculation part 44 as torque calculation means, and an output part 45.

The signals are input to the input part 41 respectively from the first detection sensor 31, the second detection sensor 32, and the third detection sensor 33. Then, the input part 41 acquires, based on the signal input from the first detection sensor 31, for example, the steering angle of a steering wheel operated by the driver, the accelerator operation amount and the throttle opening degree caused by the operation on the accelerator pedal, the brake operation amount caused by the operation on the brake pedal, the on/off states of the ignition switch, the charge state of the electricity storage device 24, and the like. Moreover, the input part 41 acquires, based on the signal input from the second detection sensor 32, for example, the vehicle speed of the vehicle 10, the roll rate, the pitch rate, and the yaw rate on the vehicle body 10a, and the like. Further, the input part 41 acquires, based on the signal input from the third detection sensor 33, for example, a degree of unevenness of a road surface on which the vehicle 10 is traveling, strength of an influence of a crosswind on the vehicle 10, and the like. In this way, the input part 41 outputs the acquired various detection values to the vehicle body behavior control command value calculation part 42.

The vehicle body behavior control command value calculation part 42 has a function of using the various detection values from the input part 41, to thereby calculate a target longitudinal driving force as a control command value for controlling the vehicle 10 to travel, and calculate control command values (a target roll moment, a target pitch moment, and a target yaw moment) for controlling the behaviors generated on the vehicle body 10a. The vehicle body behavior control command value calculation part 42 outputs respective command values representing the calculated target longitudinal driving force, target roll moment, target pitch moment, and target yaw moment to the driving force distribution calculation part 43.

The driving force distribution calculation part 43 has a function of calculating respective driving forces to be generated by distributing the target longitudinal driving force, the target roll moment, the target pitch moment, and the target yaw moment to the respective wheels 11 to 14 based on the command values from the vehicle body behavior control command value calculation part 42. The driving force distribution calculation part 43 outputs the calculated respective driving forces to the torque calculation part 44.

The torque calculation part 44 has a function of calculating the torques to be generated by the respective motors 19 to 22 in correspondence to the respective driving forces calculated by the driving force distribution calculation part 43. For example, the torque calculation part 44 sets the same reference torque (reference torque T₀ described later) to the respective four motors 19 to 22 in response to the signal input from the first detection sensor 31, for example, first information on the input operation by the driver. In this case, a torque that is four times as large as the reference torque matches a torque required to be generated by all of the four motors 19 to 22. Further, the torque calculation part 44 calculates torques acquired by distributing distributed torques (distributed torques ΔT described later) to the reference torque in response to the signal input from the second detection sensor 32, for example, second information on the motion state (the roll motion, the pitch motion, and the yaw motion) of the vehicle 10. Then, the torque calculation part 44 outputs the calculated torques to the output part 45. In this case, the torque calculation part 44 has a function of practically carrying out the torque control for the motors 19 to 22 capable of independently driving the four wheels 11 to 44, and constructs “control part” of the present invention.

The output part 45 outputs drive signals corresponding to the torques calculated by the torque calculation part 44 to the inverter 23. With this, the inverter 23 controls drive power (drive current) to be supplied to the respective motors 19 to 22, to thereby drive the respective motors 19 to 22. Thus, the driving torques are generated on the respective wheels 11 to 14. As a result, the vehicle 10 can be controlled to appropriately travel depending on the operation state by the driver. Further, the roll motion, the pitch motion, and the yaw motion on the vehicle body 10a can be appropriately controlled.

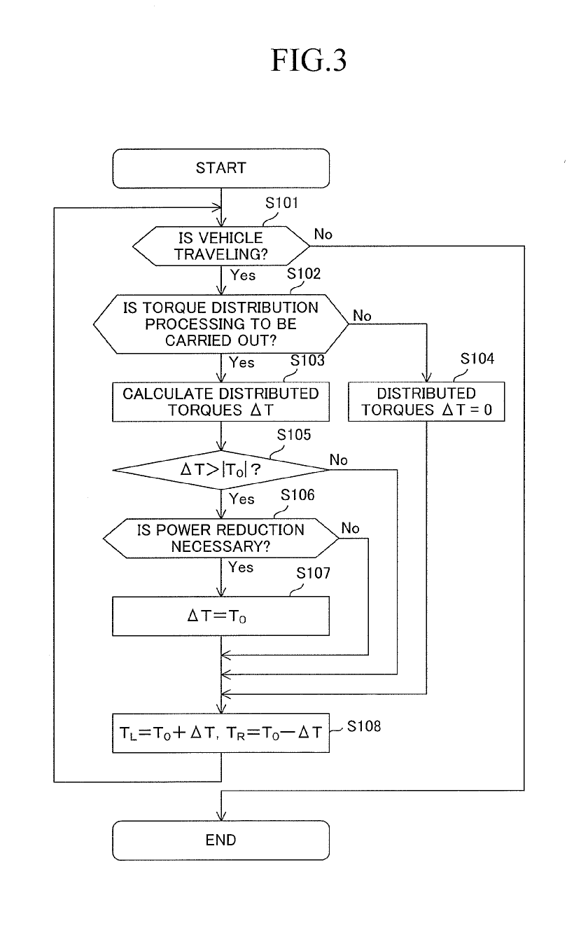

This embodiment has a feature of using motor torque control illustrated in FIG. 3 particularly when the torques to be generated respectively by the two motors 19 and 20 are calculated by the torque calculation part 44. This motor torque control is such control that the two motors 19 and 20 corresponding to each other in the lateral direction (direction indicated by the arrow D1 of FIG. 1) of the vehicle 10 are each controlled to generate appropriate torques, and includes processing of Steps S101 to S108 of FIG. 3. This motor torque control is practically carried out by the control unit 30 including the torque calculation part 44. This motor torque control is included in “wheel control method” of the present invention.

In processing of Step S101, it is determined whether the vehicle 10 is traveling or not. For this determination, the first detection sensor 31 and the second detection sensor 32 can be used. For example, the vehicle 10 is determined to be traveling when the “off” state of the parking brake is detected by the parking brake sensor as the first detection sensor 31, when the “on” state of the ignition switch is detected by the ignition sensor, or when the vehicle speed is detected by the vehicle speed sensor as the second detection sensor 32. When it is determined that the vehicle 10 is traveling (Yes in Step S101), the motor torque control proceeds to Step S102. On the other hand, when it is determined that the vehicle 10 is not traveling (No in Step S101), the motor torque control ends as it is.

In processing of Step S102, it is determined whether the torque distribution processing is to be carried out or not. When the torque distribution processing is to be carried out (Yes in Step S102), the motor torque control proceeds to Step S103. On the other hand, when the torque distribution processing is not to be carried out (No in Step S102), the motor torque control proceeds to Step S104.

In processing of Step S103, the initial distributed torques ΔT (≧0) to be used for the torque distribution processing is calculated, and then, the motor torque control proceeds to Step S105. The distributed torques ΔT are set in order to carry out a torque distribution to the predetermined reference torque T₀ respectively for the two motors 19 and 20. In this case, the initial distributed torques ΔT are set based on information detected by, for example, at least one of the first detection sensor 31 or the second detection sensor 32. Moreover, the distributed torques ΔT may be the same value for the two motors 19 and 20, or may be different values for the respective motors. On the other hand, the initial distributed torques ΔT may be constant values set in advance.

In processing of Step S104, it has been determined that the torque distribution processing is not to be carried out, and the motor torque control thus sets the distributed torques ΔT to zero. The motor torque control then proceeds to Step S108.

In processing of Step S105, the magnitude of the distributed torque ΔT calculated in Step S103 is compared with an absolute value of the reference torque T₀ (namely, a magnitude of the reference torque T₀). When the magnitude of the distributed torque ΔT is more than the absolute value of the reference torque T₀ (Yes in Step S105), the motor toque control proceeds to Step S106. On the other hand, when the magnitude of the distributed torque ΔT is equal to or less than the absolute value of the reference torque T₀ (No in Step S105), the motor toque control proceeds to Step S108.

In processing of Step S106, it is determined whether or not it is necessary to reduce the power in order to suppress the power consumption. Typically, for example, the electricity storage sensor as the second detection sensor 32 acquires information on a state of charge (SOC) of the electricity storage device 24, and the acquired information is used to determine whether or not it is necessary to reduce the power. In this case, the electricity storage device 24 corresponds to “electricity storage device” of the present invention. On this occasion, “SOC” is a unit for representing a state of charge, and represents a ratio (%) of a remaining charge amount to an electricity storage capacity in a fully charged state. When the acquired SOC is less than a predetermined threshold set in advance, it is determined that the ratio of the remaining charge amount is relatively low, and hence it is necessary to reduce the power. Then, the motor torque control proceeds to Step S107 for limiting the distributed torques ΔT. On the other hand, when the acquired SOC is more than the predetermined threshold set in advance, it is determined that the ratio of the remaining charge amount is relatively high, and hence it is unnecessary to reduce the power. Then, the motor torque control skips Step S107 for limiting the distributed torques ΔT and proceeds to Step S108. In other words, when it is unnecessary to reduce the power consumption, the distributed torques ΔT are not limited. With this, whether the distributed torque is to be limited or not can be selected in response to a request issued as necessary by the electricity storage device 24 or the like, which is rational. Moreover, the predetermined threshold may be a constant value set in advance, or a variable value variably set depending on the vehicle motion state and the like. Moreover, when the necessity for the power reduction is not determined, Step S106 may be omitted.

In processing of Step S107, the magnitude of the distributed torque ΔT is set to match the magnitude of the reference torque T₀. With this, when the magnitude of the distributed torque ΔT is more than the absolute value of the reference torque T₀, the magnitude of the distributed torque ΔT can be limited by matching the magnitude of the distributed torque ΔT with the magnitude of the reference torque T₀. In other words, Step S107 is processing effective when the power reduction is necessary. In this case, the change of the torque in the acting direction can be reliably prevented for each of the motors 19 and 20 by simply selecting the magnitude of each of the distributed torques ΔT depending on the magnitude of the reference torque T₀. Note that, in the processing of Step S107, other than such a limitation that the magnitude of the distributed torque ΔT matches the magnitude of the reference torque T₀, such a limitation can be made that the magnitude of the distributed torque ΔT is less than the magnitude of the reference torque T₀. In other words, it is only necessary that the magnitude of the distributed torque ΔT be limited to be equal to or less than the magnitude of the reference torque T₀. In this case, the change of the torque in the acting direction can be reliably prevented for each of the motors 19 and 20 by selecting the magnitude of each of the distributed torques ΔT in a predetermined range depending on the magnitude of the reference torque T₀.

In processing of Step S108, a torque T_{L} of the motor 19 for the front left wheel 11 is reset by distributing the distributed torque ΔT to the reference torque T₀ through addition, and a torque T_{R} of the motor 20 for the front right wheel 12 is reset by distributing the distributed torque ΔT to the reference torque T₀ through subtraction. With this, for the motor 19 for the front left wheel 11, a drive signal corresponding to the reset torque T_{L} is output from the torque calculation part 44 to the inverter 23 via the output part 45. Further, for the motor 20 for the front right wheel 12, a drive signal corresponding to the reset torque T_{R} is output from the torque calculation part 44 to the inverter 23 via the output part 45. On the other hand, for both of the motor 21 for the rear left wheel 13 and the motor 22 for the rear right wheel 14, drive signals corresponding to the reference torque T₀ are output from the torque calculation part 44 to the inverter 23 via the output part 45. Then, after the processing of Step S108 is finished, the motor torque control returns to Step S101.

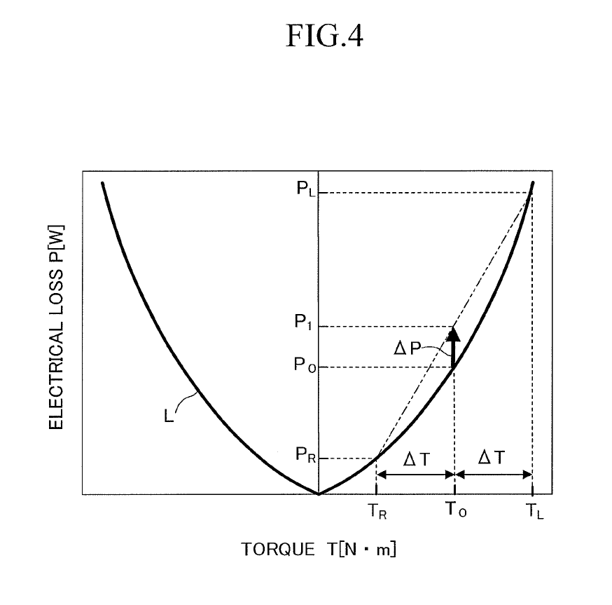

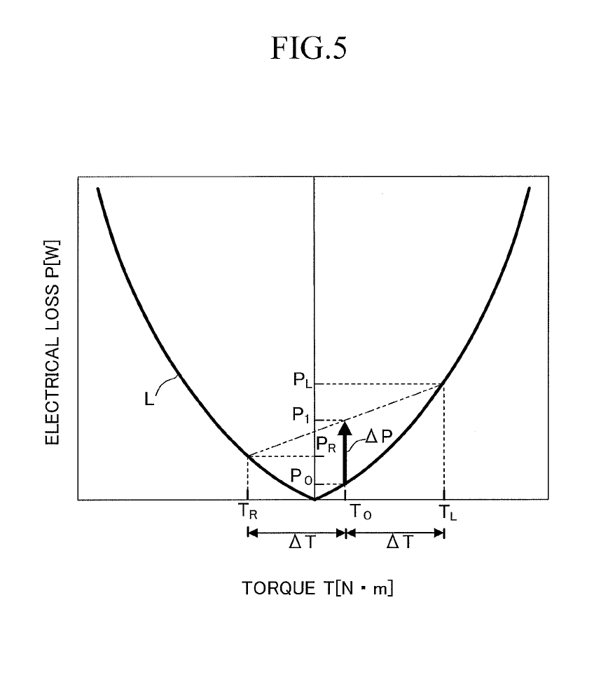

The processing from Step S105 to Step S108 forms a distributed torque limitation mode. In the distributed torque limitation mode, depending on the second information on the motion state of the vehicle 10, the motor 19 (first motor) is controlled at the torque acquired by distributing the distributed torque ΔT (first distributed torque) to the reference torque T₀ through addition, and the other motor 20 (second motor) is controlled at the torque acquired by distributing the distributed torque ΔT (second distributed torque) to the reference torque T₀ through subtraction. Further, the distributed torques are limited so as to prevent the acting directions of the torques from changing before and after the distribution through addition and the distribution through subtraction respectively for the motors 19 and 20. FIGS. 4 and 5 are referred to for actions and effects of this distributed torque limitation mode.

Incidentally, there is known such a characteristic of each of the motors 19 and 20 that while a torque proportional to a current is generated, an electrical loss of the motor is defined by an inverter loss proportional to the current and a motor loss proportional to a square of the current. Thus, for the relationship between the torque (proportional to the current) and the electrical loss of the motor, the curve L having a sharp-pointed protrusion shown in FIGS. 4 and 5 is referred to.

FIG. 4 shows an electrical loss when the distributed torque ΔT is limited by the motor torque control of FIG. 3 so that the magnitude of the distributed torque is not more than the absolute value of the reference torque T₀. In this case, on the motor 19 for the front left wheel 11, the electrical loss increases from a reference loss P₀ to P_{L} along the curve L due to an increase in the torque from the reference torque T₀ to T_{L} by ΔT. On the other hand, on the motor 20 for the front right wheel 12, the electrical loss decreases from the reference loss P₀ to P_{R} along the curve L due to a decrease in the torque from the reference torque T₀ to T_{R} by ΔT. As a result, an electrical loss of those motors 19 and 20 as a whole increases from the reference loss P₀ to a final loss P₁ (average value of P_{L} and P_{R}) by ΔP.

In contrast, FIG. 5 shows an electrical loss when the magnitude of the distributed torque ΔT is more than the absolute value of the reference torque T₀. In this case, on the motor 19 for the front left wheel 11, the electrical loss increases from the reference loss P₀ to P_{L} along the curve L due to an increase in the torque from the reference torque T₀ to T_{L} by ΔT as in the case of FIG. 4. However, on the motor 20 for the front right wheel 12, when the torque decreases from the reference torque T₀ to T_{R} by ΔT, such a phenomenon occurs that the sign of the torque inverts unlike the case of FIG. 4. In this case, the electrical loss once decreases from the reference loss P₀ along the curve L, and then increases to P_{R}. In other words, a phase switches from the one in which the electrical loss of the motor 20 decreases to the one in which the electrical loss increases. As a result, the magnitude of ΔP, which is the increase in the electrical loss of the motors 19 and 20 as a whole, is more than the magnitude of ΔP in the case of FIG. 4. In other words, the electrical loss is larger in the case of FIG. 5 than in the case of FIG. 4.

Thus, when FIGS. 4 and 5 are referred to, the limitation on the distributed torques ΔT by the motor torque control of FIG. 3 prevents the acting directions of the torques of both of the motors 19 and 20 from changing between the driving direction (powering direction) and the braking direction (regenerating direction) before and after the torque distribution. In other words, the sign of the torques are prevented from changing. In particular, the sign of the torque is prevented from inverting in the process of the reduction of the distributed torque ΔT from the reference torque T₀ on the second motor 20, and hence the phase does not switch from the one in which the electrical loss of this motor decreases to the one in which the electrical loss increases. As a result, the increase in the electrical loss of the motors 19 and 20 as a whole can be suppressed, and hence the increase in the power consumption can be suppressed. Thus, while the vehicle motion is appropriately controlled, it is possible to suppress the increase in the power consumption, which may be caused by the control.

Moreover, according to this embodiment, both of the distributed torques relating to the motors 19 and 20 are set to the distributed torques ΔT having the same magnitude, and hence the change in the total driving torque of at least the two wheels before and after the torque distribution is suppressed. Consequently, the control can be performed without providing a sense of discomfort to a vehicle occupant of the vehicle. It should be understood the torque distribution is not carried out for the other motors 21 and 22, and hence a change in a total driving torque of the four wheels before and after the toque distribution is suppressed.

The present invention is not limited to the above-mentioned typical embodiment, and various applications and modified examples are conceivable. For example, the following modes to which the above-mentioned embodiment is applied can be carried out.

While the case in which the above-mentioned distributed torque limitation mode is applied only to the two motors 19 and 20 relating to the front left and right two wheels 11 and 12 out of the four motors 19 to 22 is described for the motor torque control of FIG. 3, the present invention can be applied to a case in which the distributed torque limitation mode is applied only to the two motors 21 and 22 relating to two wheels including the rear left and right wheels 13 and 14, and a case in which the distributed torque limitation mode is applied to the four motors 19 to 22 relating to all the wheels 11 to 14.

When the distributed torque limitation mode is carried out for the four motors 19 to 22, the distributed torques ΔT can be distributed through addition to the reference torque T₀ for two respective motors selected depending on operation motion states (typically, the roll motion, the pitch motion, and the yaw motion) of the vehicle 10, and the distributed torques ΔT can be distributed through subtraction to the reference torque T₀ for the other two respective motors. In addition, the distributed torques ΔT relating to the respective motors can be limited.

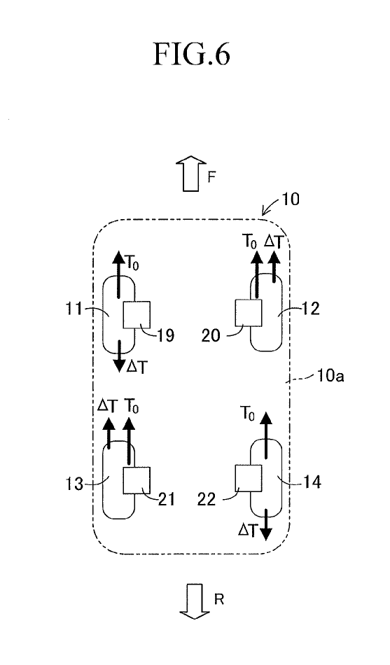

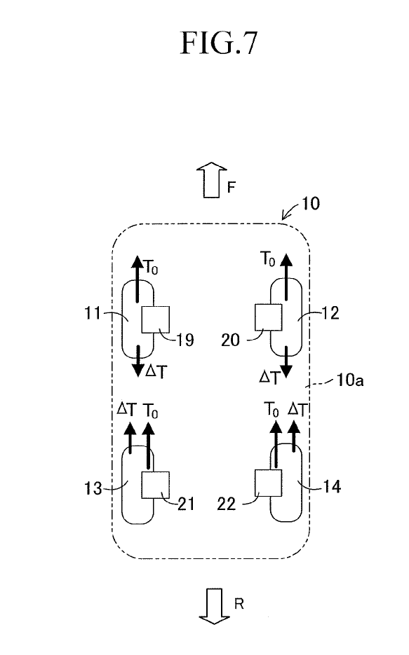

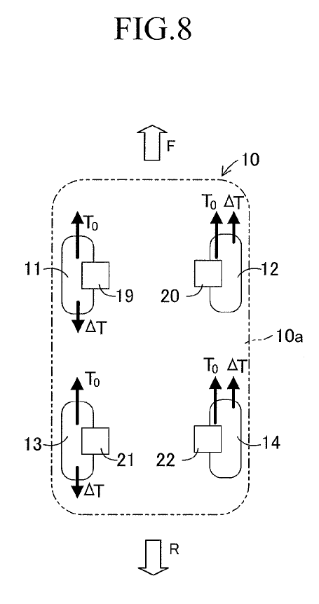

Regarding the roll motion control on the vehicle 10, for example, as illustrated in FIG. 6, the distributed torques ΔT can be distributed through addition to the reference torque T₀ for the motor 20 for the front right wheel 12 and the motor 21 for the rear left wheel 13, and the distributed torques ΔT can be distributed through subtraction to the reference torque T₀ for the motor 19 for the front left wheel 11 and the motor 22 for the rear right wheel 14 depending on information (first motion information) on the roll motion of the vehicle 10. Moreover, regarding the pitch motion control on the vehicle 10, for example, as illustrated in FIG. 7, the distributed torques ΔT can be distributed through addition to the reference torque T₀ for the motor 21 for the rear left wheel 13 and the motor 22 for the rear right wheel 14, and the distributed torques ΔT can be distributed through subtraction to the reference torque T₀ for the motor 19 for the front left wheel 11 and the motor 20 for the front right wheel 12 depending on information (first motion information) on the pitch motion of the vehicle 10. Moreover, regarding the yaw motion control on the vehicle 10, for example, as illustrated in FIG. 8, the distributed torques ΔT can be distributed through addition to the reference torque T₀ for the motor 20 for the front right wheel 12 and the motor 22 for the rear right wheel 14, and the distributed torques ΔT can be distributed through subtraction to the reference torque T₀ for the motor 19 for the front left wheel 11 and the motor 21 for the rear left wheel 13 depending on information (second motion information) on the yaw motion of the vehicle 10.

Further, a priority level is preferably provided for the limitation on the distributed torques in the distributed torque limitation mode depending on the above-mentioned operation motions of the vehicle 10. For example, it is preferred that while the distributed torque limitation mode is selected when the roll motion control or the pitch motion control is carried out, the distributed torque limitation mode be not selected when the yaw motion control is carried out. In short, the priority level of the limitation on the distributed torque is set to be higher to the pitch motion control or the roll motion control relating to the ride comfort of the vehicle occupant of the vehicle than to the yaw motion control relating to steering stability of the vehicle 10. With this, the vehicle motion can be appropriately controlled so that, while the ride comfort of the vehicle occupant of the vehicle is sacrificed, the steering stability of the vehicle 10 is prevented from being lost as much as possible, and further, it is possible to suppress the increase in the power consumption, which may be caused by this control.

The four-wheel motor vehicle and the two-wheel motor vehicle are described above in the embodiment, but the number of wheels and the number of the plurality of motors for independently driving those wheels are not limited, and can be properly changed depending on a request in design and the like. In this case, the distributed torques can be limited for all or a part of the plurality of motors.

Based on the description of the embodiment and the various modified examples, the present invention can take the following respective aspects.

In the present invention, the following aspect (Aspect 1) can be employed.

“A wheel control method according to claim 10, further including limiting, in the distributed torque limitation mode, when a magnitude of at least one of the first distributed torque or the second distributed torque is more than a magnitude of the predetermined reference torque, the at least one of the first distributed torque or the second distributed torque so that the magnitude of the at least one of the first distributed torque or the second distributed torque is equal to or less than the magnitude of the predetermined reference torque, to thereby prevent the change in the acting direction of the torque for each of the one or a plurality of first motors and the one or a plurality of second motors.”

In the present invention, the following aspect (Aspect 2) can be employed.

“A wheel control method according to Aspect 1, further including limiting, in the distributed torque limitation mode, when the magnitude of at least one of the first distributed torque or the second distributed torque is more than the magnitude of the predetermined reference torque, the at least one of the first distributed torque or the second distributed torque so that the magnitude of the at least one of the first distributed torque or the second distributed torque matches the magnitude of the predetermined reference torque, to thereby prevent the change in the acting direction of the torque for each of the one or a plurality of first motors and the one or a plurality of second motors.”

In the present invention, the following aspect (Aspect 3) can be employed.

“A wheel control method according to any one of claim 10 and Aspects 1 and 2, in which:

the plurality of motors only include one first motor built into one of a left wheel and a right wheel corresponding to each other out of the plurality of wheels and one second motor built into another one of the left wheel and the right wheel; and the wheel control method further includes setting the first distributed torque relating to the one first motor and the second distributed torque relating to the one second motor to the same magnitude.”

In the present invention, the following aspect (Aspect 4) can be employed.

“A wheel control method according to any one of claim 10 and Aspects 1 and 2, in which:

the plurality of motors only include two first motors respectively built into two wheels out of four wheels serving as the plurality of wheels and two second motors respectively built into two wheels other than the two wheels; and

the wheel control method further includes setting the first distributed torque relating to each of the two first motors and the second distributed torque relating to each of the two second motors to the same magnitude.”

In the present invention, the following aspect (Aspect 5) can be employed.

“A wheel control method according to Aspect 4, in which:

the second information includes first motion information on a roll motion or a pitch motion of the vehicle and second motion information on a yaw motion of the vehicle; and

the, wheel control method further includes: selectively carrying out any one of roll motion control or pitch motion control of setting the first distributed torque and the second distributed torque based on the first motion information and yaw motion control of setting the first distributed torque and the second distributed torque based on the second motion information; selecting the distributed torque limitation mode when the roll motion control or the pitch motion control is carried out; and avoiding selecting the distributed torque limitation mode when the yaw motion control is carried out.”

In the present invention, the following aspect (Aspect 6) can be employed.

“A wheel control method according to any one of claim 10 and Aspects 1 to 5, further including avoiding limiting, in the distributed torque limitation mode, when a reduction in a power consumption is not necessary on the plurality of motors, the first distributed torque and the second distributed torque.”

In the present invention, the following aspect (Aspect 7) can be employed.

“A wheel control method according to Aspect 6, further including determining, when, in an electricity storage device installed on the vehicle as a drive source of the plurality of motors, a ratio of a remaining charge amount to a charge capacity in a fully charged state is more than a predetermined threshold, the reduction in the power consumption on the plurality of motors is not necessary.”

1. A wheel control device configured to control a plurality of wheels provided for a vehicle, the wheel control device comprising a control part configured to carry out torque control for a plurality of motors capable of independently driving the respective plurality of wheels,
the control part being configured to set a predetermined reference torque to each of the plurality of motors based on first information on an input operation by a driver, and comprising a distributed torque limitation mode in which: one or a plurality of first motors out of the plurality of motors are controlled at a torque acquired by distributing a first distributed torque to the predetermined reference torque through addition to the predetermined reference torque based on second information on a motion state of the vehicle; one or a plurality of second motors different from the one or a plurality of first motors are controlled at a torque acquired by distributing a second distributed torque to the predetermined reference torque through subtraction from the predetermined reference torque; and the first distributed torque and the second distributed torque are limited so as to prevent, for each of the one or a plurality of first motors and the one or a plurality of second motors, an acting direction of the torque from changing before and after the distribution through addition and the distribution through subtraction.

2. A wheel control device according to claim 1, wherein, in the distributed torque limitation mode, when a magnitude of at least one of the first distributed torque or the second distributed torque is more than a magnitude of the predetermined reference torque, the control part limits the at least one of the first distributed torque or the second distributed torque so that the magnitude of the at least one of the first distributed torque or the second distributed torque is equal to or less than the magnitude of the predetermined reference torque, to thereby prevent the change in the acting direction of the torque for each of the one or a plurality of first motors and the one or a plurality of second motors.

3. A wheel control device according to claim 2, wherein, in the distributed torque limitation mode, when the magnitude of the at least one of the first distributed torque or the second distributed torque is more than the magnitude of the predetermined reference torque, the control part limits the at least one of the first distributed torque or the second distributed torque so that the magnitude of the at least one of the first distributed torque or the second distributed torque matches the magnitude of the predetermined reference torque, to thereby prevent the change in the acting direction of the torque for each of the one or a plurality of first motors and the one or a plurality of second motors.

4. A wheel control device according to claim 1, wherein:
the plurality of motors only comprise one first motor built into one of a left wheel and a right wheel corresponding to each other out of the plurality of wheels and one second motor built into another one of the left wheel and the right wheel; and
the control part sets the first distributed torque relating to the one first motor and the second distributed torque relating to the one second motor to the same magnitude.

5. A wheel control device according to claim 1, wherein:
the plurality of motors only comprise two first motors respectively built into two wheels out of four wheels serving as the plurality of wheels and two second motors respectively built into two wheels other than the two wheels; and
the control part sets the first distributed torque relating to each of the two first motors and the second distributed torque relating to each of the two second motors to the same magnitude.

6. A wheel control device according to claim 5, wherein:
the second information comprises first motion information on a roll motion or a pitch motion of the vehicle and second motion information on a yaw motion of the vehicle; and
the control part is configured to: selectively carry out any one of roll motion control or pitch motion control of setting the first distributed torque and the second distributed torque based on the first motion information and yaw motion control of setting the first distributed torque and the second distributed torque based on the second motion information; select the distributed torque limitation mode when the roll motion control or the pitch motion control is carried out; and avoid selecting the distributed torque limitation mode when the yaw motion control is carried out.

7. A wheel control device according to claim 1, wherein, in the distributed torque limitation mode, when a reduction in a power consumption is not necessary on the plurality of motors, the control part avoids limiting the first distributed torque and the second distributed torque.

8. A wheel control device according to claim 7, wherein when, in an electricity storage device installed on the vehicle as a drive source of the plurality of motors, a ratio of a remaining charge amount to a charge capacity in a fully charged state is more than a predetermined threshold, the control part determines that the reduction in the power consumption on the plurality of motors is not necessary.

9. A vehicle, comprising:
a plurality of wheels;
a plurality of motors capable of independently driving the respective plurality of wheels; and
a motor control device configured to control the plurality of motors,
wherein the motor control device comprises the wheel control device of claim 1.

10. A wheel control method for controlling a plurality of wheels provided for a vehicle, the wheel control method comprising, in torque control for a plurality of motors capable of independently driving the respective plurality of wheels, the steps of:
setting a predetermined reference torque to each of the plurality of motors based on first information on an input operation by a driver; and
using a distributed torque limitation mode in which: one or a plurality of first motors out of the plurality of motors are controlled at a torque acquired by distributing a first distributed torque to the predetermined reference torque through addition to the predetermined reference torque based on second information on a motion state of the vehicle; one or a plurality of second motors different from the one or a plurality of first motors are controlled at a torque acquired by distributing a second distributed torque to the predetermined reference torque through subtraction from the predetermined reference torque; and the first distributed torque and the second distributed torque are limited so as to prevent, for each of the one or a plurality of first motors and the one or a plurality of second motors, an acting direction of a torque from changing before and after the distribution through addition and the distribution through subtraction.
